(19) United States
(12) Patent Application Publication
(10) Pub. No.: US 2014/0340472 A1
(43) Pub. Date: Nov. 20, 2014

(54) PANORAMIC BIFOCAL OBJECTIVE LENS

(71) Applicant: PAN-VISION S.R.L, Treviso (TV) (IT)

(72) Inventor: Claudio Pern Echele, Teolo (PD) (IT)

(21) Appl. No.: 14/370,210

(22) PCT Filed: Dec. 17, 2012
(86) PCT No.: PCT/IT2012/000382

§ 371 Date: Jul. 1, 2014

(30) Foreign Application Priority Data
Jan. 3, 2012 (IT) VI2012A000004

(51) Int. Cl. G02B 13/06; G02B 17/08; H04N 5/232

(52) U.S. Cl. CPC G02B 13/06; H04N 5/23238; G02B 17/08
USPC 348/36

(57) ABSTRACT

The invention relates to an optical device (40) for obtaining an enlargement of a given area of a 360° panoramic field of view, which is applicable to an optical system (20) for obtaining a 360° panoramic field of view, which comprises a retro reflector (3) with an outer convex spherical surface (1) and an image sensor (18) for digital processing the field of view:
the optical device (40) comprises a magnifying optical element (6), which is fixable to the retro-reflector (3) in correspondence with the outer convex spherical surface (1), and deflector means (19).

The invention also relates to an optical system (20) comprising said optical device (40), an apparatus for filming the images and an apparatus for projecting the images comprising said optical system (20).

The present invention relates to the field of the optical devices and, in particular, relates to an optical device for obtaining an enlargement of a given area of a 360° panoramic visual field.

More in detail, the optical device of the invention is applicable to an optical system for obtaining a 360° panoramic image and can be freely operated by a user, without interfering with the operation of said optical system.

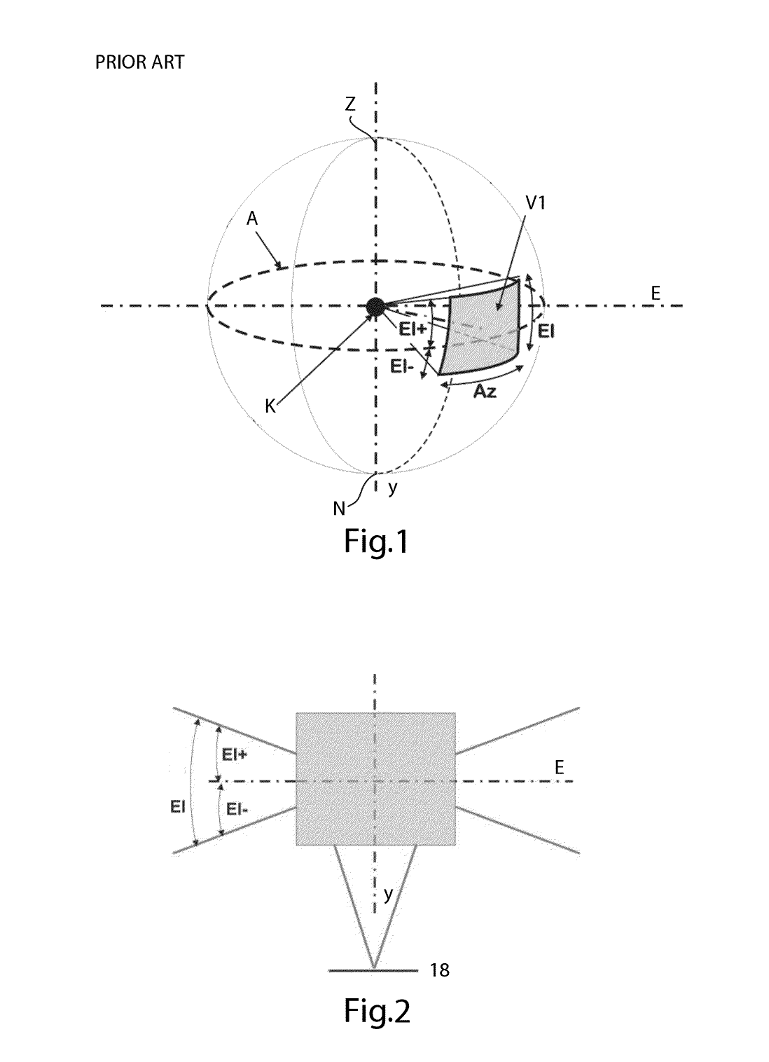

Currently, vision cameras are able to catch visual fields that are relatively narrow and confined, such as, for example, the visual field V1 shown in FIG. 1. In order to film the space surrounding the visual field V1, the operator must physically point the camera, in a manual way or by means of motorized systems, towards the area of which he/she wants to acquire the images.

During a single image acquisition it is possible to see, and—in case it is considered appropriate—“catch”, or record on a support (for example a digital sensor), only a small portion of the horizon.

A panoramic image of a given scene can only be obtained by taking several images and after a reworking and elaboration of said images, which must be merged together to obtain the requested panoramic view.

However, this operating mode is particularly burdensome when it is necessary to have a panoramic vision in a given time instant, since the final panoramic image is given by the superposition of images that are taken in different time instants. If the panoramic scene is dynamic (with moving people or objects), in fact, the final panoramic image does not correspond to the reality at a given time instant.

With reference to FIGS. 1-4, Az is the lens view angle along the horizon plane A around the azimuth axis Y while El is the angle along the direction that is orthogonal to the horizon plane A around the elevation axis E.

Regarding the measurements, Az can have values from 0° to 360°, while El can have values from 0° at the horizon A up to +90° at the Zenith Z or down to −90° at the Nadir N.

Of course, Az and El can also have different values. This happens, for example, when the image sensor is rectangular or when the lens is in a peculiar configuration, the so-called anamorphic configuration, according to which the magnifications (zoom) along the two axes are different one from each other.

Typical lenses with wide-field (wide-angle lenses) have angles of Az and El measuring at most a few tens of degrees. Other particular lenses, called “fisheye”, have view angles of Az=360° and El=+90°.

In recent years, many ideas have been developed to achieve lenses able to have angles of Az=360° and El>90°, such as panoramic lenses, that are made using mirrors of particular shapes and able to intercept light rays coming from areas below horizon.

These technical solutions provide a significant extension of the image which can be obtained for example from the typical lens called “fisheye”.

Some examples can be found in some prior patent documents, such as Brueggemann (U.S. Pat. No. 3,203,328, 1965), Pinzone et al (U.S. Pat. No. 3,846,809, 1974), King (U.S. Pat. No. 4,326,775, 1980), Rosendahl & Dykes (U.S. Pat. No. 4,395,093, 1983), Cox (U.S. Pat. No. 4,484,801, 1984), Kreischer (U.S. Pat. No. 4,561,733, 1985), Nayar (U.S. Pat. No. 5,760,826, 1998), Davis et al. (U.S. Pat. No. 5,841,589, 1998), in which a plane mirror instead of a curved mirror is used.

The prior art patent document on behalf of Kuroda et al. (U.S. Pat. No. 5,854,713, 1998) discloses a system with two aspherical mirrors.

The prior art documents Greguss (U.S. Pat. No. 4,566,763, 1986) and Hall & Ehtashami (U.S. Pat. No. 4,670,648, 1987) relates to a reflector instead of a mirror.

The prior art documents Powell (U.S. Pat. No. 5,473,474, 1995) and Powell (U.S. Pat. No. 5,631,778, 1997) relate to a retro-reflector with multiple reflections, so as to decrease the angle of the principal rays and facilitate the correction of optical aberrations.

Some authors have also developed panoramic objectives with zooming capabilities (King, U.S. Pat. No. 4,429,957, 1981) or with different resolutions within the same system (Cook, U.S. Pat. No. 5,710,661, 1998).

More recently, with the advent of digital sensors and computing means, optical vision systems together with computational algorithms have developed so as to provide panoramic images more clear for a user.

A “fisheye” lenses' application is disclosed in Poelstra (U.S. Pat. No. 5,563,650, 1996).

Another patent document on behalf of Wallerstein et al. (U.S. Pat. No. 6,373,642, 2002) relates to a spherical reflector with a reflective surface that is able to obtain visual fields up to El=−60°.

The optical systems of the lenses that are described in the literature and cited above have a generic configuration, such as the configuration shown in FIG. 2, which shows a section view obtained along a plane perpendicular to the horizon.

The optical system, shown generically in FIG. 2 as a “black-box”, has different configurations depending on the type of application, as described in the above mentioned patent documents.

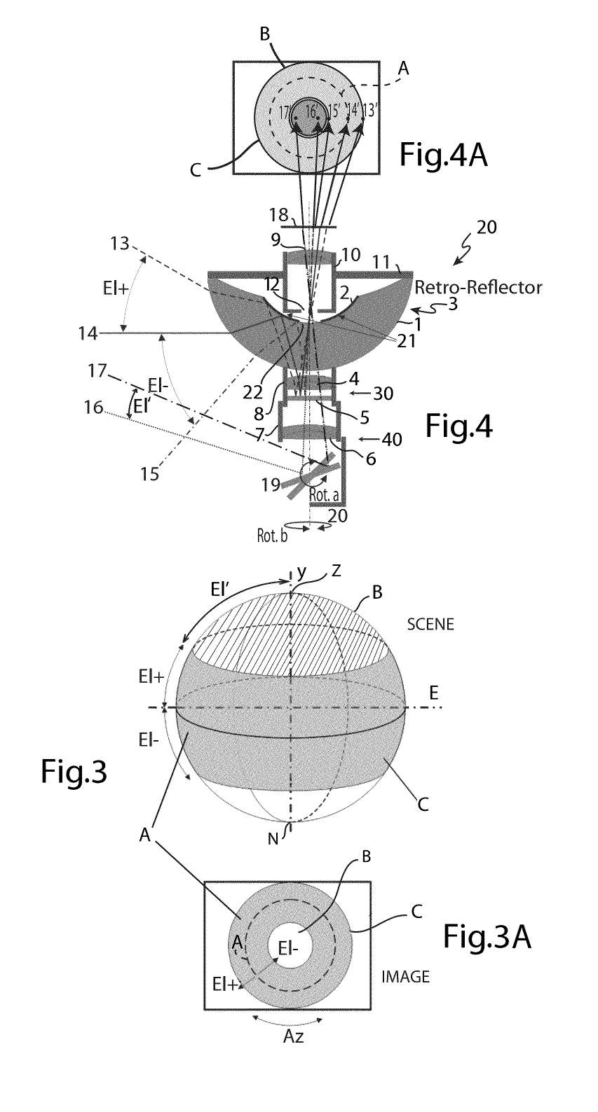

The generic system shown in FIG. 2 produces an image on the focal plane in the shape of an annulus, as shown in FIG. 3A.

The physical size of the outer circumference of the annulus is determined by the focal length of the optical system and it can be chosen depending on the application, while the relative size of sauid circumference (i.e. the ratio between the larger radius and the minor radius) depends on the choice of the maximum value of the angle El (absolute value).

In particular, the size of the area corresponding to the inner circle of the annulus constitute the main drawback of the apparatus, because they correspond to the portion of the sensor that is not exploited.

Some authors have tried to optimize the acquisition also exploiting the central part of the annulus, by catching the blind area near the Zenith point Z.

For example, the patent document Beckstead & Nordhauser (U.S. Pat. No. 6,028,719, 2000) discloses a lens system for a frontal view (90°>El>45°) and a plurality of mirrors for a lateral view (El<45°), while the patent document Driscoll et al. (U.S. Pat. No. 6,341,044, 2002) discloses retro-reflector for a lateral view (El<90°) and a separate optical system for viewing the area close to the Zenith Z.

Other technical modern solutions use a reflector to catch the rays coming from the elevation angles around the horizon (even up to values ranging between El−=−60° and El+=+45°), while further lenses are provided for dimensioning the visual field on the focal plane and to correct optical aberrations.

However, as shown in the figures of the above mentioned prior art patent documents, the image sensor and the related electronic devices (and therefore the respective cables) are placed from the outer side, which is exposed to the view.

This feature is considerably negative for video-surveillance, since the camera is particularly cumbersome, both from an aesthetic point of view and from the point of view of a clear vulnerability.

In fact, an attacker who wants to disable the camera is able to easily locate it and he/she is able to easily cut the electric cables.

Another similar technical solution is described in US 2009/073254, which discloses a system for acquiring omnidirectional images, comprising an aspherical convex mirror (eg. a hyperbolic mirror) and a known lenses system passing through a central opening of the hyperbolic mirror. The magnification is performed by a suitable device which is placed in correspondence of the known lenses system.

Said patent document discloses the use of an aspherical convex mirror, rather than a fisheye-type lens or an annular panoramic-type lens (PAL), because said lenses are very expensive, difficult to made and not able to exploit the whole acquiring surface.

Therefore, it is suggested to use said convex aspheric mirror, in which a central opening can be performed, so as to apply therein the above-mentioned device.

However, the use of said convex aspheric mirror restricts the visual field to the space above the horizon.

In addition, the magnifying device needs to be supported by some rods for fixing it to the aspheric mirror. These rods have also the drawback of constituting an obstruction for the visual field.

An object of the present invention is therefore to obviate the above mentioned drawbacks of the prior art and in particular to provide an optical device for obtaining an enlargement of a given area of a 360° panoramic visual field, which can be applied to an optical system able to produce a 360° panoramic visual field in azimuth so as to exploit a sensor device in all its parts.

Again, an object of the invention is to provide an optical device for obtaining an enlargement of a given area of a 360° panoramic visual field, which can be applied in a removable manner to an optical system able to obtain a 360° panoramic visual field in azimuth.

Furthermore, an object of the present invention is to provide an optical device for obtaining an enlargement of a given area of a 360° panoramic visual field, which is easy to make and cheap.

Another object of the invention is to provide an optical system for obtaining a 360° panoramic visual field in azimuth and also below the horizon, without any obstructions. These and other objects are achieved by an optical device for obtaining a magnification of a given area of a 360° panoramic visual field, according to the appended claim 1, which is referred to for sake of brevity; further detailed characteristics are described in the dependent claims.

Advantageously, the present invention relates to the realization of an optical device for obtaining an enlargement of a given area of a 360° panoramic visual field, i.e. the visual field C shown in FIG. 3, in which Az=360° and the angle El has, in the specific example described heretofore, values corresponding to El−=−60° and El+=+45°.

Said image is compatible with a panoramic image having 360° of azimuth, which can be obtained by a suitable optical system, so as to acquire a total visual field of 360° in azimuth and 270° in elevation.

The vision is instantaneous and therefore it is possible to correctly register a dynamic panoramic scene, with moving objects and people.

Further objects and advantages of the present invention will become clear from the description which follows, which refers to a preferred embodiment of the optical device for obtaining a magnification of a given area of a 360° panoramic visual field, which is the object of the invention, and from the enclosed drawings, in which:

FIG. 1 shows a three-dimensional diagram sketching the visual field that is detectable by optical systems according to the prior art;

FIG. 2 shows a two-dimensional diagram sketching the visual field that is detectable by optical systems according to the prior art;

FIG. 3 shows a three-dimensional diagram sketching the visual field that is detectable by optical systems for acquiring a 360° panoramic image;

FIG. 3A shows a two-dimensional diagram sketching the visual field that is detectable by the optical system of FIG. 3;

FIG. 4 shows a section view of the optical system of FIG. 3, to which the optical device of the invention is applied;

FIG. 4A shows a two-dimensional diagram sketching the visual field that is detectable by the optical system of FIG. 4.

A particular optical system, to which the optical device of the invention can be applied, will be disclosed in the following, by way of example. This means that the optical device of the invention can be applied to another optical system, which is however able to acquire a 360° panoramic image in azimuth.

The enclosed FIG. 4 shows:
a beam 14, shown by a continuous line, coming from an object located in correspondence of the horizon, in which El=0°,
a beam 13, shown by a dashed line, coming from an object placed at the upper edge of the field El+,
a beam 15, shown by a dash-dotted line, coming from an object placed below the horizon El−, at an angle between the horizon and the Nadir N,
a beam 16, shown by a dotted line, and a beam 17, shown by a dashed-two dotted line, said beams coming from two respective objects placed in a visual field between E+ and El− (between +45° and −60°, according to the embodiment of the invention).

The optical system 20 comprises an optical element or retro-reflector 3, a first optical unit 30, a sensor 18 for acquiring the image, and a lens 9.

The first optical unit 30 includes a first lens group 4 and a semi-reflective mirrored surface 5, which are assembled together in a support 8, preferably made of metal, for fixing the optical unit 30 to the retro-reflector 3 so that the first lens group 4 is placed at a given distance from the retro-reflector 3.

In particular, the support 8 is fixed to the retro-reflector 3, i.e. the metal is bonded to the glass.

In another embodiment of the optical unit 30, the first optical unit 30 is directly fixed to the retro-reflector 3 by bonding the lens group 4.

In a further embodiment of the optical unit 30, the mirrored surface 5 is constituted by a semi-reflective coating which is directly deposited on the outer surface of the lens group 4.

In any case, the semi-reflective mirrored surface 5 is able to reflect a part of the incident light and to transmit the remaining portion.

In particular, for example, the semi-reflective mirrored surface 5 passes 50% of the light and reflects 50% of the light.

The retro-reflector 3 is able to collect the beams from each azimuth angle (from 0° to 360°) and is also able to re-direct said beams toward the first optical unit 30.

The retro-reflector 3 is substantially a lens with a first outer convex spherical surface 1 and a second inner concave spherical surface 2, and the lens 9 is placed in a position opposite to the outer convex spherical surface 1 with respect to the retro-reflector 3.

The inner concave surface 2 has a first area 21, which is made reflective by depositing a coating suitable for the purpose, and a second area 22, circular and central, through which the beams or rays 13, 14, 15, 16 and 17 pass, after being reflected (the beams or rays 13, 14 and 15) or transmitted (the beams or rays 16 and 17) from the semi-reflective mirrored surface 5.

In correspondence of the inner concave surface 2 of the retro-reflector 3, a known lens 9 is placed for collecting the beams outputting from the second area 22-, the lens 9 is specially designed for the specific application, according to known techniques and parameters, such as the required visual field, the spatial resolution or others.

The lens 9 has a diaphragm 12, which is rigidly fixed to the lens 9 by means of a common metallic support 10. Of course, the opening-stop or diaphragm 12 of the lens 9 may be placed anywhere within the support 10.

The metal support 10 is fixed in its turn to the retro-reflector 3 by means of a flange 11.

The lens group 4 allows to reduce the incidence angle of the beams or rays with the lens 9.

The rays or beams 13, 14 and 15 which are comprised between El+ and El− affect the outer convex surface 1 of the retro-reflector 3 and are directed towards the inner concave surface 2 of the retro-reflector 3.

The light is reflected from the surface 2 and directed back toward the central part of the surface 1.

The rays or beams 13, 14 and 15 thus enter the first lens group 4 and are reflected from the semi-reflective mirrored surface 5 and re-directed towards the lens 9.

During the way the rays 13, 14 and 15 again pass through the lens group 4 and the retro-reflector 3.

The optical system 20 creates the image of the panoramic scene on the focal plane 18 in the shape of an annulus or circular crown C, as shown in FIG. 3A.

In this embodiment, shown in FIG. 4, El+ is equal to 45° and El− is equal to −60°: the total visual elevation field is therefore 105°.

Before reaching the lens 9, the rays pass through the stop-opening or diaphragm 12 of the lens 9, which is thus able to control the amount of light which must enter the lens 9.

The lens 9 corrects, in turn, the optical aberrations and creates a corrected image on the image sensor or focal plane 18.

FIG. 4A shows the image which is projected on the focal plane 18 of the example shown in FIG. 4.

In particular, the image of the object transmitted by the beam 13 is focused at the point 13′, on the outer edge of the circular crown C.

Similarly, the images of objects placed on the horizon O and then transmitted to the optical system along the beam 14, or images of objects transmitted by the beam 15 are formed respectively at the points 14′ and 15′ on the focal plane. The first lens group 4 and the semi-reflective mirrored surface 5 are fixed to the retro-reflector 3 by means of the metal support 8.

Advantageously, this optical system 20 may be applied to the optical device 40, according to the invention.

With reference to the enclosed FIG. 4, the optical device 40 includes an optical element 6, mounted on a support 7 which is made preferably of metal and which is fixed to the support 8 through suitable connection means, for example threaded means.

The optical element 6 has deflecting means 19, rotatably fixed to a support 20 which is provided with three-dimensional rotating means (not shown), for example a ball joint, which is in turn fixed to the support 7.

Said deflecting means 19 can rotate according to the directions of the two arrows rot.a (around the elevation axis) and rot.b (around the azimuth axis) and are able to catch a visual field between E+ and El− (between +45° and −60°, according to the embodiment). Many rotation systems are now available and they can be used to the above mentioned purpose, therefore a detailed description of one of them is not the purpose of the present invention.

In particular, the focal length of the optical element 6 is dimensioned so as to form the image of the visual field EL′, after which the rays 16 and 17 are passed through the semi-reflective mirrored surface 5, the first optical unit 30 and the lens 9.

The image produced by the second optical device 40 on the focal plane 18 is constituted by the circle B, which is exactly placed in correspondence of the hole of the annulus C created by the optical system 20.

The combined focal length of the optical system 20 with the optical device 40 is dimensioned so as to form a magnified image of the field El′ between the rays 16 and 17.

By rotating the deflecting means 19 on the plane defined by the arrow rot.a, it is possible to catch all the visual fields included within the original panoramic field between E+ and El− (105°, according to the embodiment of the invention) and a magnification of said visual fields can be seen directly on the image sensor placed on the focal plane 18.

A rotation of the deflecting means 19 and a possible rotation of the support 20 about the axis of symmetry of the optical system, i.e. on the plane defined by the arrow rot.b, allows the system to move in azimuth and then to catch magnified images of the whole original panoramic field.

The fact that the central region of the circular crown C of the panoramic image is not affected by the image sensor advantageously allows to find a free area in which the magnification can be projected without interfering with the panoramic vision.

In other words, the operator can advantageously continue to see both the whole original panoramic visual field and a related magnified region, by using a single image sensor.

Using different and interchangeable optical elements 6, there may be different magnification values, depending on the practical application. In particular, 3×, 6×, etc. optical zoom can be used, for example.

In a preferred embodiment of the device 40 according to the invention, the deflecting means 19 comprise a mirrored surface.

According to another embodiment of the device 40, the deflecting means 19 comprise any other optical system—for example a prism—which is able to catch rays and return them in a definite direction.

In particular, the embodiment shown in FIG. 4 refers to an optical system which is able to catch the rays 16 and 17 within the original panoramic field between El+ and El− and return them toward the magnified lens 6.

More generally, according to the invention, one of the mirrored surfaces 21 or 5—or both—may be replaced by any other optical system able of catching rays and return them in a definite direction, for example an optical prism (not shown).

Equally advantageously, the optical system 20 can be used both projecting and filming the images.

When the images are projected, unlike the focal plane 18, a slide or an LCD screen or any image to be projected can be used; the light exits the retro-reflector and is projected on a projection surface (one hemispherical screen or the walls and the ceiling of a room or of a building).

The present invention has been described for illustrative but not limitative purposes, according to a preferred embodiment, but it is to be understood that variations and/or modifications may be made by the man skilled in the art without departing from the relevant scope of protection, as defined by the appended claims.

1. Optical device (40) for obtaining an enlargement of a certain area of a 360° panoramic field of view, applicable to an optical system (20) for obtaining a 360° panoramic field of view, said optical system (20) comprising a catadioptric lens (3) having an outer convex spherical surface (1) and an image sensor (18) for digital processing said field of view, said optical device (40) comprising an enlarging optical element (6), fixable to said catadioptric lens (3) in correspondence of said outer convex spherical surface, and deflecting means (19) suitable for capturing rays from said certain area of said 360° panoramic field of view and for sending back said rays to said optical element (6), said optical element (6) transmitting said rays (16, 17) to said image sensor (18).

2. Optical device (40) according to claim 1, characterized in that said deflecting means (19) are rotatabily fixed to a support (20) provided with threedimensional rotating means, so as said deflecting means (19) can be oriented towards any area of said 360° panoramic field of view, both in azimuth and in elevation alike.

3. Optical device (40) according to claim 1, characterized in that said optical system (20) transmits to said image sensor (18) an annular image (C), having a smaller circle (B), and in that said optical device (40) transmits to said image sensor (18) an image which is comprised within said smaller circle (B).

4. Optical device (40) according to claim 1, characterized in that said deflecting means (19) comprise a reflecting surface.

5. Optical device (40) according to claim 1, characterized in that said deflecting means (19) comprise a prism.

6. Optical system (20) for obtaining, in a single acquisition, a 360° panoramic image, comprising a catadioptric lens (3) a photographic lens (9) and an image sensor (18) for digital processing said image; said catadioptric lens (3) comprising a spherical lens having a first outer convex spherical surface (1) and a second concave interior spherical surface (2), said first and second spherical surfaces (1, 2) having a respective centre, said centres defining a first optical axis; photographic lens (9) having a second optical axis coinciding with said first optical axis, and comprising a stop (12) opposed to said image sensor (18); said optical system (20) being characterized in that said photographic lens (9) is fixed to said catadioptric lens (3) in correspondence of said second concave interior spherical surface (2), oriented—with said stop (12) facing to said catadioptric lens (3), and in comprising an optical device (40) according to claim 1.

7. Optical system (20) according to claim 6, characterized in that said second concave interior spherical surface (2) of said catadioptric lens (3) has a first central area (22) completely transparent and a second area (21), surrounding said first area (22) and having a reflecting surface, and in having a first optical unit (30), comprising a semi-reflective surface (5), and having a third optical axis, coinciding with said first optical axis and second optical axis.

8. Optical system (20) according to claim 6, characterized in that said first optical unit (30) comprises a first group of lenses (4), suitable for reducing the angle of incidence on said photographic lens (9), which is interposed between said first outer convex spherical surface (1) of said catadioptric lens (3) and said semi-reflective surface (5).

9. Apparatus for recording three-dimensional images, comprising an optical system (20) according to claim 6.

10. Apparatus for projecting three-dimensional images, comprising an optical system (20) according to claim 6.
